(19) United States
(12) Patent Application Publication
(10) Pub. No.: US 2005/0090173 A1
(43) Pub. Date: Apr. 28, 2005

(54) Nonwoven materials comprising low density fibers and absorbent articles comprising such fibers

(75) Inventor: Paul Thomas Weisman, West Chester Township, OH (US)

Correspondence Address: THE PROCTER & GAMBLE COMPANY;INTELLECTUAL PROPERTY DIVISION, WINTON HILL TECHNICAL CENTER - BOX 161, 6110 CENTER HILL AVENUE, CINCINNATI, OH, 45224, US

(73) Assignee: The Procter & Gamble Company

(21) Appl. No.: 10/954,039

(22) Filed: Sep. 29, 2004

Related U.S. Application Data
(60) Provisional application No. 60/514,343, filed on Oct. 24, 2003.

(51) Int. Cl. B32B 5/18; B32B 7/02; D04H 1/00; B32B 5/24

(52) U.S. Cl. 442/339; 442/314; 442/335; 442/336; 428/218; 442/381; 442/394; 442/370

(57) ABSTRACT

Low density fibers and nonwoven materials comprising such fibers suitable for use in absorbent articles are disclosed. The nonwoven materials are in the form of a fibrous web and the fibers are made up of struts which define open and closed cells. The fibers have a fiber density that is less than the density of the polymer composition that is extruded to form the fibers. Depending on their final use in an absorbent article, the material can be either hydrophilic or hydrophobic. Hydrophilic materials, are suitable for topsheets and core components and have desirable fluid handling properties such as a liquid strike-through time of less than about 10 seconds, an absorptive capacity greater than about 4 grams per gram and a medium capillary desorption height of less than about 150 cm. The preferred materials for backsheets and cuffs are hydrophobic and have a repellency greater than 0 cm.

### CROSS REFERENCE TO RELATED APPLICATION

This application claims the benefit of U.S. Ser. No. 60/514,343, filed Oct. 24, 2003.

### FIELD OF THE INVENTION

The present invention relates to low denier, low density fibers, webs comprising such fibers, and disposable articles comprising such nonwoven webs.

### BACKGROUND OF THE INVENTION

Nonwoven webs formed by nonwoven extrusion processes such as, for example, meltblowing and spunbonding processes may be manufactured into products and components of products so inexpensively that the products could be viewed as disposable after only one or a few uses. Representative products of this type include disposable absorbent articles, such as diapers, incontinence briefs, training pants, feminine hygiene garments, wipes, and the like.

There is continuing consumer need for nonwovens that can deliver superior fluid handling performance and product aesthetic performance while using less material when used in disposable products. A key function served by nonwoven materials in disposable absorbent products is receipt, distribution and storage of body exudates, including aqueous fluids. When the nonwoven material comprises a synthetic or semi-synthetic fiber, such fibers typically have a cross section that is substantially solid polymer. Such solid polymer poses an environmental burden. For example, when a disposable absorbent article has become soiled, it enters the waste stream for ultimate disposal as solid waste. The mass of synthetic fiber either remains in the ultimate waste disposal location (e.g., a landfill) or biodegrades if exposed to conditions amenable to biodegradation. In either event, sending less material into the waste stream is desirable.

The inherent cost of a nonwoven is related to the weight of material used per unit of the nonwoven's area or volume. When the nonwoven material comprises a synthetic or semi-synthetic fiber, such fibers typically have a cross section that is substantially solid polymer. If the nonwoven were to comprise fibers of a material with a discontinuous cross section containing zones corresponding to voids without any material, then less material would be required and therefore the cost of the nonwoven would be reduced.

Similarly, the cost to distribute an absorbent article depends, among other factors, on the shipping weight of the article. Obviously, it takes more fuel to carry a heavier article than a lighter one. Thus, an article comprising a nonwoven that uses less material, while providing desirable fluid handling performance, will have a lower distribution cost, both in actual dollars spent (less fuel means less dollars) and in reduced air pollution (less fuel use means fewer exhaust emissions). Distribution packaging (i.e., weight of the shipping container) also can be reduced if the weight of the article is reduced because less container material will needed because product weight is lower.

There is also a need to provide the designers of absorbent articles with additional design flexibility. For example, one way to provide increased capillarity in a nonwoven structure is to provide a nonwoven web at a first nonwoven density and then calendar and consolidate the web at a higher second density. However, such an approach may increase the stiffness of the nonwoven. If the designer had the ability to perform such a densification process using nonwoven webs comprising fibers that are less stiff than those currently available, the stiffness of the consolidated web would be improved (i. e. softer webs could be obtained after densification).

There are several approaches that have been used in the art to create low density resilient nonwovens:
U.S. Pat. No. 3,227,784 describes a flash extrusion process for preparing microcellular and other molecularly oriented polymer structures. The structures can comprise ultramicrocellular yarns and sheets which are uniform and opaque, even in thin sections.
U.S. Pat. No. 5,997,980 describes hollow polyester fibers that have high resistance to compression and a high recovery from compression.
Published European Patent Application EP 0 278 476 A2 describes a sausage-shaped liquid absorbing article which includes within a porous fabric fine, fibrous particles of flash-spun polyethylene, optionally particles of foamed organic polymer and an effective amount of a wetting agent.
Published PCT Application No. WO 99/00098 describes fluid acquisition/transfer layers for absorbent articles where the acquisition/transfer layer comprises spiralized thermoplastic fibers.
Published PCT Application No. WO 02/29144 describes compression midsoles for shoes that comprise at least 70 vol. % randomly oriented ultramicrocellular fibers mutually adhered using a thermoset adhesive binder. The ultramicrocellular fibers are formed by flash spinning a thermoplastic polymer.
   Thus, there exists within the industry today an umnet need for low density nonwovens and absorbent articles made therefrom which have desirable fluid handling properties and comprising moderate to low denier fibers that can be made from conventional resins.

### SUMMARY OF THE INVENTION

Low density fibers and nonwoven materials comprising such fibers suitable for use in absorbent articles are disclosed. The nonwoven materials comprise a fibrous web which fibers comprise a multiplicity of struts which define open and closed cells therebetween. The fibers have a fiber density that is less than the density of the polymer composition that is extruded to form the fibers. Depending on their final use in an absorbent article, the material can be either hydrophilic or hydrophobic. Hydrophilic materials, suitable for topsheets and core components can have desirable fluid handling properties such as a liquid strike-through time of less than about 10 seconds, an absorptive capacity greater than about 4 grams per gram and a medium capillary desorption height of less than about 150 cm. The preferred materials for backsheets and cuffs are hydrophobic and have a repellency greater than 0 cm.

### BRIEF DESCRIPTION OF THE DRAWINGS

FIG. 1 is a plan view of an absorbent article incorporating the nonwoven materials of the present invention.

FIG. 2 is a cross sectional view of a portion of an absorbent article showing a barrier cuff that incorporates a nonwoven material of the present invention.

### DETAILED DESCRIPTION OF THE INVENTION

As used herein, the term “absorbent article” refers to devices that absorb and contain body exudates, and, more specifically, refers to devices that are placed against or in proximity to the body of the wearer to absorb and contain the various exudates discharged from the body.

The term “disposable” is used herein to describe absorbent articles that are not intended to be laundered or otherwise restored or reused as an absorbent article (i.e., they are intended to be discarded after a single use and, preferably, to be recycled, composted or otherwise disposed of in an environmentally compatible manner).

As used herein, the term “nonwoven web”, refers to a web that has a structure of individual fibers or threads which are interlaid, but not in any regular, repeating manner. Nonwoven webs have been, in the past, formed by a variety of processes including: air laying processes, hydroentangling processes, meltblowing processes, spunbonding processes, flash spinning processes, electrostatic spinning processes, and carding processes, including bonded carded web processes. These processes can be done in combinations where the fibers from more than one of the forming process are deposited onto a permeable substrate and then consolidated into a unitary nonwoven web.

As used herein, the term “microfibers” refers to small diameter fibers having an average diameter not greater than about 100 microns, and a length-to-diameter ratio of greater than about 10. Those trained in the art will appreciate that the diameter of the fibers comprising a nonwoven web impact its overall softness and comfort, and that the smaller denier fibers generally result in softer and more comfortable products than larger denier fibers. For fibers of the present invention, it is preferable that the diameters are in the range of about 5 to 25 microns to achieve suitable softness and comfort, more preferably in the range from about 10 to 25 microns in diameter, and even more preferable in the range from about 10 to 20 microns in diameter. The fiber diameter or equivalent diameter is determined using the method described in the TEST METHODS section below.

Although the nonwoven web of the present invention can find beneficial use as a component of a disposable absorbent article, such as a diaper, its use is not limited to disposable absorbent articles. The nonwoven web of the present invention can be used in any application requiring, or benefiting from, softness and extensibility, such as wipes (including absorbent towels and tissues), polishing cloths, furniture linings, durable garments, body cleansing wipes, wet or dry floor cleaning wipes, dish cleaning wipes, and the like.

Low Density Nonwovens

It has been surprisingly found that nonwoven webs comprising low density fibers have a highly desirable combination of reduced material usage and advantageous fluid handling properties that provide a designer of absorbent articles with increased product design flexibility.

The low density fibers of the present invention can impart several advantageous properties to disposable products. For example, the use of low density fibers can allow the nonwoven manufacturer to increase the number of filaments and/or fibers in a fabric for a given basis weight, or conversely, to lower the basis weight of a fabric without lowering the number of filaments and/or fibers. This can improve the barrier properties of the fabrics without unduly increasing basis weight. This can also improve resistance to bleed through of adhesives and improve superabsorbent polymer containment and strikethrough/rewet for hygiene applications, due to the increased number of filaments and/or fibers for a given basis weight. Still further, the nonwoven materials of the invention can exhibit improved (higher) opacity as compared to fabrics formed of solid filaments.

The fibers comprising the nonwoven comprise a multiplicity of struts which define a multiplicity of open and closed cells therebetween. Causing the fibers to have a foam-like structure. The struts have dimensions substantially smaller than the macro dimensions of the fibers. Typically, the struts have a thickness dimension less than about 50% of the apparent fiber diameter, preferably less than about 20%, more preferably the strut thickness is less than about 10% of the apparent fiber diameter. Typically, the strut thickness is less than about 10 microns, preferably less than about 5 microns. More preferably, the strut thickness is less than about 2 microns.

Such a foam-like structure has several advantages:
Since the fibers comprise both polymeric material and void space, the amount of polymeric material used to produce the fibers is reduced. Such reduction has environmental, nonwoven cost, and nonwoven and absorbent article distribution cost advantages.
Since the fibers of the present invention are effectively dimensionally identical to prior art fibers used in nonwoven materials, the nonwoven materials of the present invention can have all of the properties necessary for superior performance in an absorbent article while using less material. Optionally, the weight reduction could be converted to deliver more fibers per unit area if it were more important to improve absorbent capacity versus reducing mass per unit area.
It is also believed that the fibers comprising the nonwoven of the present invention cause the nonwoven to be softer than prior art nonwoven materials at equivalent nonwoven density because the fibers are more flexible due to the reduced amount of polymeric material therein.
It is still further believed that the low density fibers comprising the nonwoven materials of the present invention have superior opacity at a given basis weight compared to nonwoven materials comprising solid fibers because the void space therein provides a multiplicity of internal points of reflection causing incident light to diffuse and increasing the opacity of the nonwoven. Additionally, at a given basis weight, there are more fibers for a nonwoven with the low density fibers of this invention. This further increases the points of reflection within the nonwoven causing incident light to diffuse increasing its opacity.
   Fiber Composition

Fibers suitable for the present invention have a polymer composition comprising polymeric materials that are also generally suitable for use in prior art nonwovens. The desirable properties are provided by using a flash spinning process to produce low density fibers. As used herein, the term “polymer composition” generally includes thermoplastic polymers of a broad variety of types such as, homopolymers, copolymers, such as, for example, block, graft, random and alternating copolymers, terpolymers, etc., and blends and modifications thereof, but is not limited to the types listed herein. Furthermore, unless otherwise specifically limited, the term “polymer composition” shall include all possible molecular configurations of a polymeric material. These configurations include, but are not limited to, isotactic, syndiotactic and random symmetries. Examples of suitable thermoplastic polymers for use in the present invention include, but are not limited to polyethylene, polypropylene, polyethylene-polypropylene copolymers, polyvinyl alcohol, polyesters, nylon, polylactides, polyhydroxyalkanoates, aliphatic ester polycondensates, and mixtures thereof. Preferred polymer compositions comprise polyolefins such as polyethylene and polypropylene, or polyesters such as poly(ethylene terephthalate) and copolymers thereof and hydrophilic polyesters. Additional suitable polyesters include, but are not limited to, poly(lactic acid) (e.g., Lacea from Mitsui Chemicals, or EcoPLA from Dow Cargill), poly(caprolactone) (e.g., Tone P787 from Union Carbide), poly(butylene succinate) (e.g., Bionolle 1000 series from Showa Denko), poly(ethylene succinate) (e.g., Lunare SE from Nippon Shokubai), poly(butylene succinate adipate) (e.g., Bionolle 3000 series from Showa Denko), poly(ethylene succinate adipate), aliphatic polyester-based polyurethanes (e.g., Morthane PN03-204, PN03-214, and PN3429-100 from Morton International), copolyesters of adipic acid, terephthalic acid, and 1,4-butanediol (e.g., Eastar Bio from Eastman Chemical Company, and Ecoflex from BASF), polyester-amides (e.g., BAK series from Bayer Corporation), hydrolyzable aromatic/aliphatic copolyesters (e.g., Hytrel and Biomax from DuPont), cellulose esters (e.g., cellulose acetate, cellulose acetate butyrate, and cellulose acetate propionate from Eastman Chemical Company), combinations and copolymers thereof, and the like.

The polymer compositions may further include various nonpolymeric components including, among others, nucleating agents, inflatants, antiblock agents, antistatic agents, slip agents, pro-heat stabilizers, antioxidants, pro-oxidant additives, pigments, fillers and the like. These additives may be employed in conventional amounts as may be desired.

A further optional component of the polymer composition is a surfactant material that increases the wettability of the nonwoven material of the present invention. The surfactant may be either incorporated into the polymer matrix before the fibers are spun or applied to the fibrous assembly after it is formed. Suitable methods of treating a nonwoven material with a surfactant are described in U.S. Pat. No. 4,950,254 and in U.S. Pat. No. 5,520,875.

Nonwoven Properties

Depending on the intended end use or the nonwoven material of the present invention, the material will have various combinations of properties so as to tailor the nonwoven to its intended use. Such properties can be provided by adjusting the polymer composition, fiber diameter, fiber density, nonwoven density and the like.

Fiber Density

At least a portion of the fibers in the nonwoven webs of the present invention have a fiber density that is less than the density of the polymer composition extruded to form the fibers (referred to hereafter as “polymer density”). As is described below, this reduced density is provided by extruding the fibers using a flash spinning process. Preferably, at least a portion of the fibers comprising a zone, region, or layer of the nonwoven webs of the present invention have a fiber density that is less than 50% of the polymer density, more preferably less than about 25%, still more preferably less than about 10%. In certain particularly preferred embodiments, the fiber density is less than about 5% of the polymer density or even less than about 2% of the polymer density. Methods for measuring fiber density and polymer density are described in the TEST METHODS section below.

Liquid Strike-Through Time

For nonwoven webs that are intended to be fluid handling components (e. g. topsheets, acquisition layers, distribution layers or even storage layers) of an absorbent article it is important that aqueous fluids are able to pass therethrough. A suitable measure of the ability of a liquid to pass through a fibrous assembly is given in EDANA (European Disposables and Nonwovens Association) Standard Method 150.4-99-Liquid Strike-Through Time. For example a material suitable for use as a topsheet in an absorbent article should have a liquid strike-through time of less than about 10 seconds, preferably less than about 5 seconds, more preferably less than about 3 seconds, still more preferably less than about 2 seconds. Materials suitable for other components in a diaper wherein fluid is transferred through the material or distributed within the material will preferably have liquid strike-through times the same as a material suitable for use as a topsheet.

Absorption

Materials suitable for use as a core component (acquisition layer, distribution layer, storage component, and the like) also need to have satisfactory absorption properties. EDANA Standard Method 10.3-99 (Absorption) describes three methods suitable for evaluating various absorption properties: Liquid Absorbency Time, Liquid Absorbent Capacity and Liquid Wicking Rate.

In order to be suitable as a core component, a fibrous material must have a minimal absorbent capacity. For example, an acquisition member needs to be able to have the capacity to temporarily hold a fluid gush from a urinating wearer so as to rapidly remove the fluid from the body surface of the absorbent article. Thus, a suitable fibrous core component suitably has an absorbent capacity of at least about 4 grams/gram, preferably at least about 8 grams/gram, more preferably at least about 10 grams/gram. This capacity is derived substantially only from capillary storage and is essentially independent of any capacity available from osmotic storage from a superabsorbent material or capillary capacity as may be available from non fibrous structures such as a foam.

Capillary Pressure

The ability of a nonwoven web to acquire and give up aqueous liquids is also important for the nonwoven webs of the present invention. A suitable measure of such ability is capillary pressure.

As used herein the term “capillary pressure” refers to the hydrostatic pressure (also called hydrostatic head or water column height) at which the fluid loading is measured. In general, a material's ability to absorb fluid and its ability to retain fluid upon desorption may be measured. The term Medium Capillary Pressure refers to the pressure at which the material is at 50% saturation with respect to its 0 cm capacity. Since pressure might be expressed as height of a water column, the present application uses height as a preferred measure of pressure. In the case of the present invention, it is desired to define a medium height to indicate the height at which 50% of the 0 cm absorption absorbent capacity of an absorbent structure under equilibrium conditions at 22° C. is attained. Medium capillary pressures can be expressed either as a medium capillary absorption height (CAH) or as a medium capillary desorption height (CDH) depending on whether the absorbent capacity is determined under absorbing (CAH) or desorbing (CDH) conditions. The underlying theory is described by P. K. Chatterjee and H. V. Nguyen in “Absorbency,” Textile Science and Technology, Vol. 7; P. K. Chatterjee, Ed.; Elsevier: Amsterdam, 1985. A typical nonwoven web according to the present invention has a CDH less than about 150 cm. Both CAH and CDH are determined according to the Capillary Sorption method described in the TEST METHODS section below.

CAH is important because, when the nonwoven webs of the present invention are used as an acquisition layer, the materials must be able to acquire fluids from adjacent components of the absorbent article (e. g. the topsheet or a secondary topsheet). In order to be able to acquire, CAH is preferably greater than at least a portion of the desorption pressures of any adjacent structure. It has been found that for the nonwoven webs of the present invention CAH is suitably greater than about 3 centimeters, preferably greater than about 5 centimeters. A method for determining CAH is given in the TEST METHODS section below.

If the nonwoven web is intended to be an acquisition component, CDH is important relative to controlling acquired fluid and to the absorption pressure of other core components, especially those intended for fluid distribution or storage. If the fluid acquisition component of an absorbent article holds the acquired fluid too tenaciously, this will inhibit the ability of these other components to partition fluid away. In addition too great a CDH could lead to fluid rewet since too much fluid is held in the acquisition component. This can cause the acquisition component to remain so heavily loaded with fluid that it may not be able to rapidly acquire fluid from subsequent gushes making the absorbent article more susceptible to leaking. Conversely, if the acquisition component cannot control the acquired fluid against gravity, wearer motion could cause fluid flow within the acquisition component that leads to leakage adjacent the edges thereof. This means a nonwoven web of the present invention that is suitable for use as an acquisition member has a capillary desorption height (CDH value) of not more than about 40 cm, preferably not more than about 25 cm, more preferably not more than about 15 cm, and still more preferably not more than about 12 cm. CDH values should also be greater than about 5 cm to control acquired fluids against the influence of gravity. Typically, the nonwoven web will have a CDH value of from about 5 cm to about 25 cm, more typically from about 5 to about 20 cm, still more typically from about 10 to about 15 cm.

Similarly, if the nonwoven web is intended for use as a distribution component, the CAH thereof should be greater than the CDH of at least a portion of the acquisition component. Since CAH is greater than CDH, a nonwoven web suitable for use as a distribution component will suitably have a CDH greater than about 50 cm, preferably greater than about 70 cm, more preferably greater than about 100 cm. A nonwoven web according to the present invention that is suitable for use as a distribution layer will typically have a CDH between about 50 cm and 120 cm, preferably between about 70 cm and about 100 cm.

A method for determining CDH is given in the TEST METHODS section below.

Low Density Fiber Process

Low density fibers according to the present invention can be obtained by flash-spinning as described in U.S. Pat. Nos. 3,081,519, 3,227,664 and 3,227,784. In this process, a confined mixture of a polymer composition plus at least one activating liquid is heated to a temperature at which a homogeneous solution is formed. The temperature is greater than the normal boiling point of the liquid. This solution, either under an autogenuous pressure or a higher pressure, is extruded abruptly to a region of substantially lower pressure and temperature. The extrusion conditions (concentration, temperature, pressure, etc) are chosen so as to cause rapid formation of a very large number of bubble nuclei at the extrusion orifice. Liquid vaporization rapidly cools the extruded solution so as to precipitate the polymer “freezing in” the bubbles.

Such fibers are usually prepared by extruding a polymer solution having a relatively high polymer concentration therein (e.g., at least 40 weight percent synthetic fiber-forming polyolefin). Polypropylene, and polymethylpentene are suitable synthetic fiber-forming polyolefins. Low density fibers may be obtained rather than plexifilaments, even at spinning pressures slightly below the cloud point pressure of the solution. Spin agents used are the same as those used to form plexifilamentary, or film-fibril materials. Nucleating agents, such as fumed silica and kaolin, are usually added to the spin mix to facilitate spin agent flashing and to obtain uniform small size cells.

Continuous fibers, staple fibers and shaped fibers, such as multi-lobal fibers can all be produced by using the methods of the present invention. The fibers of the present invention may have different geometries that include round, elliptical, star shaped, rectangular, and other various eccentricities. As used herein, the diameter of a noncircular cross section fiber is the equivalent diameter of a circle having the same cross-sectional area.

Web Consolidation

After the fibers are formed, they are desirably consolidated to form a stabilized nonwoven web. As used herein, the terms “consolidation” and “consolidated” refer to the bringing together of at least a portion of the fibers of a nonwoven web into closer proximity to form a site, or sites, which function to increase the resistance of the web to external forces, e.g., abrasion and tensile forces, as compared to the unconsolidated web. “Consolidated” can refer to an entire nonwoven web that has been processed such that at least a portion of the fibers are brought into closer proximity, such as by thermal point bonding. Such a web can be considered a “consolidated web”. In another sense, a specific, discrete region of fibers that is brought into close proximity, such as an individual thermal bond site, can be described as “consolidated”.

Consolidation can be achieved by methods that apply heat and/or pressure to the nonwoven web, such as thermal spot (i.e., point) bonding. Thermal point bonding can be accomplished by passing the nonwoven web through a pressure nip formed by two rolls, one of which is heated and contains a plurality of raised points on its surface, as is described in U.S. Pat. No. 3,855,046. The webs of the present invention comprising low density fibers provide an advantage to such consolidation processes in that there is a lower thermal mass to melt if thermal bonding is used and a lower pressure requirement if compression bonding is used. For example, when comparing nonwoven materials formed of solid fibers with the nonwoven materials of the present invention at a constant number of fibers per unit area and constant apparent fiber diameter, the amount of polymer that needs to be melted in a bonding process is defined by the percent polymeric area because this parameter defines the percentage of the fiber cross section comprising polymeric material. Thus melting will be faster at a given temperature in thermal bonding and bonding pressure will be reduced for compression bonding. Such low thermal mass is also advantageous for consolidation processes such as ultrasonic bonding and through-air bonding.

Consolidation methods can also include, but are not limited to resin bonding and hydroentanglement. Hydroentanglement typically involves treatment of the nonwoven web with high pressure water jets to consolidate the web via mechanical fiber entanglement (friction) in the region desired to be consolidated, with the sites being formed in the area of fiber entanglement. The fibers can be hydroentangled as taught in U.S. Pat. Nos. 4,021,284 and 4,024,612.

Other Suitable Processing Operations

Staple Fiber Formation

The spun fibers can be left unconsolidated and subjected to further processing. For example, the fibers can be cut into staple length for later use as a component in a carded, wet laid or airlaid nonwoven material. The fibers of the present invention can be suitably cut into staple fibers having a length between about 25 mm and about 75 mm. Typically, the fibers of the present invention can be cut to a length of about 40 mm for use as a component in a carded, wet laid, hydroentangled, or airlaid nonwoven material.

Blending With Other Fibrous Materials

When the low density fibers of the present invention are in staple form, they can be used in combination with other staple fibers in web formation processes such as carding, wet laying and air laying to produce nonwoven webs with a wide variety of properties. The low density fibers of the present invention can be used at any desired concentration up to and including 100%. As will be recognized, the properties of the blended web will be dependent on the properties of the constituent fibers therein and the process used to form the web.

Web Finishing

Once a low density nonwoven web according to the present invention has been formed, it can be finished to put it into a form suitable for use in subsequent processes. For example the web can be slit trimmed to a finished width suitable for use in a manufacturing process to form an absorbent article. The width of the finished nonwoven web can be any width as defined by the requirements of the production process used to make a finished absorbent article. Typically, such webs have a width of at least 25 mm or wider.

Other finishing processes, such as softening operations that provide microcrepe to the web (e.g., Micrexing, Klupaking) may also be applied as part of the finishing process.

Composite Structures

In one particularly preferred use of a finished web, a composite web is formed by laminating a nonwoven material comprising low density fibers according to the present invention to a film so as to provide a composite material that is suitable for use as a cloth-like backsheet or an elasticized element (e.g., a cuff) in an absorbent article. Because the nonwovens of the present invention comprise polymeric materials that are substantially the same as are used to produce nonwoven webs comprising solid fibers, processes suitable for formation of such laminates including adhesive bonding, compression bonding and thermal point bonding are also suitable for formation of laminates comprising such low density nonwoven materials.

The nonwoven webs of the present invention take advantage of the aforementioned increased opacity compared to prior art nonwoven materials so as to provide the same cloth-like appearance at a lower nonwoven basis weight. This lower basis weight is particularly advantageous when the laminate is further processed after formation. For example, the laminate may be stretched so as to provide requisite moisture vapor permeability for breathability or “activated’ (if the film used therewith has, or can be processed to have, elastic properties) for use in an elasticized element. Examples of such stretching processes are given in U.S. Pat. No. 4,116,892, U.S. Pat. No. 4,834,741, U.S. Pat. No. 5,143,679, U.S. Pat. No. 5,156,793, U.S. Pat. No. 5,167,897, U.S. Pat. No. 5,422,172, and U.S. Pat. No. 5,518,801.

Exemplary Absorbent Article

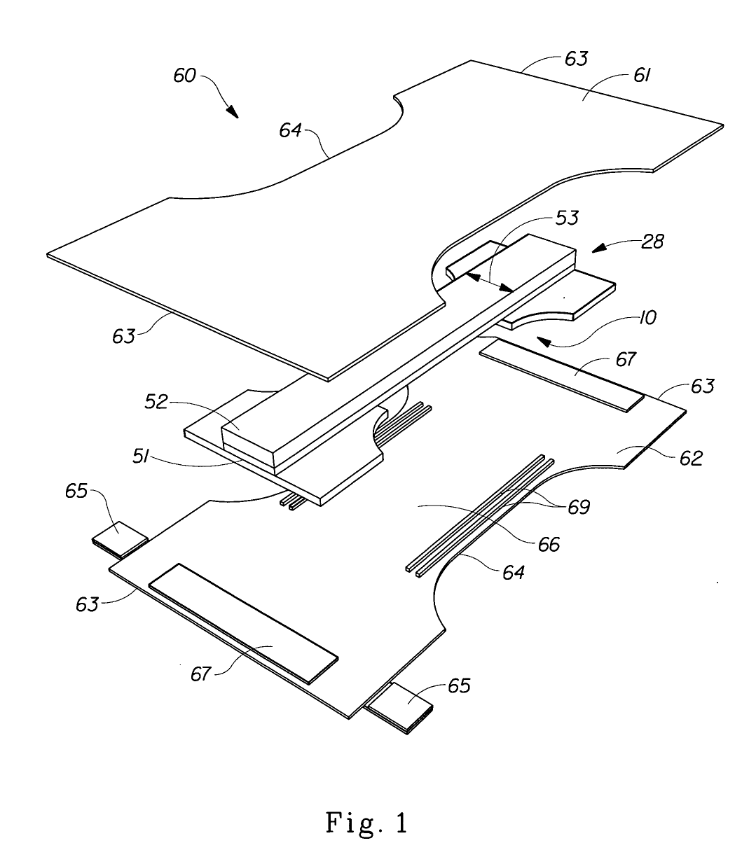

FIG. 1 shows an exemplary embodiment of a diaper 60 in which the topsheet 61 and the backsheet 62 are co-extensive and have length and width dimensions generally larger than those of the absorbent core 28. The topsheet 61 is joined with and superimposed on the backsheet 62 thereby forming the periphery of the diaper 60. The periphery defines the outer perimeter or the edges of the diaper 60.

The topsheet 61 is compliant, soft feeling, and non-irritating to the wearer's skin. Further, the topsheet 61 is liquid pervious permitting liquids to readily penetrate through its thickness. A suitable topsheet 61 according to the present invention comprises a low density nonwoven web. Typically, the topsheet 61 is made of a hydrophobic material, such as a nonwoven web comprising low density fibers flash spun from a polymer composition comprising an olefinic polymer, treated as described above to be initially hydrophilic, to isolate the wearer's skin from liquids in the storage absorbent member 10. The hydrophilic treatment causes initial wettability of the topsheet so liquid discharges can penetrate the topsheet.

A particularly preferred topsheet 61 comprises flash spun polypropylene fibers treated with a surfactant so as to make them hydrophilic and has a liquid strike-through time of about 3 seconds or less. Preferably, the topsheet 61 has a basis weight from about 18 to about 25 grams per square meter, a minimum dry tensile strength of at least about 400 grams per centimeter in the machine direction, and a wet tensile strength of at least about 55 grams per centimeter in the cross-machine direction.

The backsheet 62 is impervious to liquids and is preferably manufactured from a thin plastic film, although other flexible liquid impervious materials may also be used. The backsheet 62 prevents the exudates absorbed and contained in the storage absorbent member 10 from wetting articles which contact the diaper 60 such as bed sheets and undergarments. Preferably, the backsheet 62 is polyethylene film having a thickness from about 0.012 mm (0.5 mil) to about 0.051 centimeters (2.0 mils), although other flexible, liquid impervious materials can be used. As used herein, the term “flexible” refers to materials which are compliant and which will readily conform to the general shape and contours of the wearer's body.

A suitable polyethylene film is manufactured by Monsanto Chemical Corporation and marketed in the trade as Film No. 8020. The backsheet 62 is preferably embossed and/or matte finished to provide a more cloth-like appearance. Further, the backsheet 62 may be “breathable,” permitting vapors to escape from the absorbent core 28 while still preventing exudates from passing through the backsheet 62. It is contemplated that a backsheet that is highly breathable but substantially impervious to liquid may be desirable for certain absorbent articles. The size of the backsheet 62 is dictated by the size of the absorbent core 28 and the exact diaper design selected. In a preferred embodiment, the backsheet 62 has a modified hourglass-shape extending beyond the absorbent core 28 a minimum distance of at least about 1.3 centimeters to at least about 2.5 centimeters (about 0.5 to about 1.0 in.) around the entire diaper periphery.

The topsheet 61 and the backsheet 62 are joined together in any suitable manner. As used herein, the term “joined” encompasses configurations whereby the topsheet 61 is directly joined to the backsheet 62 by affixing the topsheet 61 directly to the backsheet 62, and configurations whereby the topsheet 61 is indirectly joined to the backsheet 62 by affixing the topsheet 61 to intermediate members which in turn are affixed to the backsheet 62. In a preferred embodiment, the topsheet 61 and the backsheet 62 are affixed directly to each other in the diaper periphery by attachment means (not shown) such as an adhesive or any other attachment means as known in the art. For example, a uniform continuous layer of adhesive, a patterned layer of adhesive, or an array of w separate lines or spots of adhesive can be used to affix the topsheet 61 to the backsheet 62.

Tape tab fasteners 65 are typically applied to the waistband region 63 of the diaper 60 to provide a fastening means for holding the diaper on the wearer. The tape tab fasteners 65 depicted are representative only. The tape tab fasteners can be any of those well known in the art, such as the fastening tape disclosed in U.S. Pat. No. 3,848,594 (Buell), issued Nov. 19, 1974, which is incorporated by reference. These tape tab fasteners or other diaper fastening means are typically applied near the corners of the diaper 60.

Elastic members 69 are disposed adjacent the periphery of the diaper 60, preferably along each longitudinal edge 64, so that the elastic members tend to draw and hold the diaper 60 against the legs of the wearer. Additionally, elastic members 67 can be disposed adjacent either or both of the waistband regions 63 of the diaper 60 to provide a waistband as well as or rather than leg cuffs. For example, a suitable waistband is disclosed in U.S. Pat. No. 4,515,595. In addition, a method and apparatus suitable for manufacturing a disposable diaper having elastically contractible elastic members is described in U.S. Pat. No. 4,081,301.

The elastic members are secured to the diaper 60 in an elastically contractible condition so that in a normally unrestrained configuration, the elastic members effectively contract or gather the diaper 60. The elastic members can be secured in an elastically contractible condition in at least two ways. For example, the elastic members can be stretched and secured while the diaper 60 is in an uncontracted condition. Alternatively, the diaper 60 can be contracted, for example, by pleating, and the elastic members secured and connected to the diaper 60 while the elastic members are in their unrelaxed or unstretched condition. The elastic members may extend along a portion of the length of the diaper 60. Alternatively, the elastic members can extend the entire length of the diaper 60, or any other length suitable to provide an elastically contractible line. The length of the elastic members is dictated by the diaper design.

When used as an absorbent core in a disposable diaper 60, a preferred embodiment of the core 28 according to the present invention is positioned such that an acquisition component 52 is in liquid communication with topsheet 61, and serves to quickly acquire and partition body exudates from the wearer's body to an absorptive distribution component 51. Adhesive bonding of acquisition component 52 to topsheet 61 may enhance the liquid communication by providing interfacial bonding and preventing topsheet separation from impeding liquid flow. A particularly preferred acquisition component 52 comprises flash spun polypropylene fibers treated with a surfactant so as to make them hydrophilic wherein the nonwoven material comprising the acquisition component 52 has an absorptive capacity greater than about 4 grams/gram and a CDH of less than about 40 cm.

The distribution component 51 moves liquid in the x and y dimensions of the core 28 and is subsequently desorbed by the storage core 10, which is a storage absorbent member of the present invention. A particularly preferred distribution component 51 comprises flash spun polypropylene fibers treated with a surfactant so as to make them hydrophilic wherein the nonwoven material comprising the distribution component 51 has an absorptive capacity greater than about 4 grams/gram and a CDH of less than about 120 cm and greater than about 50 cm.

While components 52 and 51 are shown generally as being rectilinear and of equal size, other shapes and size relationships may be utilized. As shown, the generally rectilinear components have a width 53 corresponding to a suitable width for the crotch area 66 of a disposable diaper. It is dimensions such as width 53 that define the web width of a finished low density web according to the present invention. By designing the finished web width to correspond to the width of specific components of an absorbent article waste is minimized during production of the absorbent article. As well, the length of the respective core components may be varied to provide a suitable fit for various wearer sizes.

As is shown in FIG. 1, storage core 10 provides ultimate storage for fluids absorbed by diaper 60. While storage core 10 can comprise solely a low density nonwoven according to the present invention, it preferably comprises a blend of flash spun low density fibers and a superabsorbent material to increase the storage capacity thereof. As is well known, superabsorbent materials typically have a capacity on the order of 15 grams of aqueous fluid per gram of material or greater.

There are several embodiments of storage core 10 where the low density materials of the present invention can be combined with a superabsorbent material to provide a storage core with excellent absorbent capacity. Superabsorbent material could be introduced into the flash spinning process itself so low density fibers and the superabsorbent material are combined prior to collection into an embryonic web on a forming screen prior to consolidation. With this embodiment superabsorbent material could be added to the fiber making process so as to result in a uniform distribution of superabsorbent material, a layered distribution of superabsorbent material, or other non-uniform, regionally concentrated superabsorbent material distributions with the low density fiber material.

In one embodiment of storage core 10, the low density fibers according to the present invention are blended with a superabsorbent material and air laid to form a blended airlaid web using techniques known to the art. Suitably, such a blend comprises at least about 5% superabsorbent material, preferably at least about 30% superabsorbent material, more preferably at least about 50% superabsorbent material and still more preferably at least about 70% superabsorbent material.

In yet another embodiment of storage core 10, an unconsolidated low density web in the form of a tow of fibers is opened and mixed with a superabsorbent material as described in U.S. Pat. No. 6,068,620 to form a blended intermingled web. In this embodiment the superabsorbent is present at a level of at least about 50%, preferably at a level of at least about 70%, more preferably at least about 85%. Typically, the superabsorbent concentration in this embodiment is between about 50% and about 95% superabsorbent.

In a third embodiment of storage core 10, the superabsorbent is disposed on a consolidated low density web according to the present invention. This embodiment may or may not include an additional nonwoven layer disposed between the superabsorbent and the distribution component 51. The superabsorbent may be adhered to the underlying low density nonwoven using means known to the art such as spirals of adhesive. Alternatively, an additional nonwoven layer may be disposed between the superabsorbent and the distribution layer 51 and joined to the underlying low density nonwoven layer of storage core 10, at least about the periphery thereof to form one or more pockets to contain the superabsorbent (As will be recognized, joining the overlying and underlying layers of this embodiment of storage core 10 at locations in addition to the periphery can be used to encapsulate the superabsorbent in more than one pocket.).

In use, the diaper 60 is applied to a wearer by positioning one waistband region under the wearer's back, and drawing the remainder of the diaper 60 between the wearer's legs so that the other waistband region is positioned across the front of the wearer. The tape-tab 65 or other fasteners are then secured preferably to outwardly facing areas of the diaper 60. In use, disposable diapers or other absorbent articles incorporating the storage absorbent members of the present invention tend to more efficiently store liquids and to remain dry due to the high absorbent capacity and high suction capacity of the absorbent members.

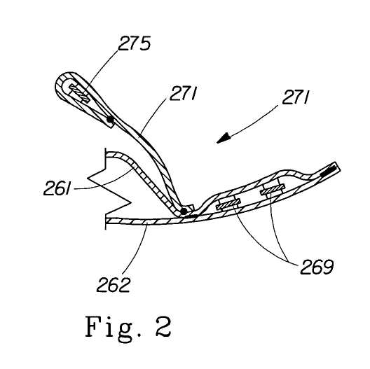

In an alternative embodiment shown in FIG. 2 an absorbent article can comprise a barrier cuff 271 that is disposed inboard of elastic members 269 (As will be recognized, elastic members 269 serve the same function of drawing and holding a diaper against a wearer's legs as do elastic members 69 of diaper 60 of FIG. 1). Such a barrier cuff is described in greater detail in U.S. Pat. No. 4,795,454. The barrier cuff 271 comprises a barrier material 273 and a barrier elastic 275. Suitably, the barrier material comprises a low density nonwoven made according to the present invention. Preferably, the barrier material 273 comprises a hydrophobic, low density nonwoven made according to the present invention. Such a hydrophobic, low density nonwoven suitably comprises low density fibers comprising a polymer composition that includes a polyolefin. As is known, polyolefinic nonwovens are substantially hydrophobic unless treated with a surfactant material so as to make them wettable. In order to have satisfactory barrier properties for use as a barrier material 273, the hydrophobic, low density nonwoven material of the present invention suitably has a repellency (EDANA Standard Method 120.1-80) that is greater than zero centimeters. Preferably, the repellency is at least about 2 cm, more preferably the repellency is at least about 7 cm, still more preferably about 10 cm. A particularly preferred barrier material has a repellency greater than about 15 cm. A method for repellency is provided in the TEST METHODS section below.

### Test Methods

Percent Polymeric Area, Fiber Density and Fiber Diameter

The diameter (or equivalent diameter) of the low density fibers and fiber density can be measured using microscopic techniques. In general, the technique makes use of images of the fibers visualized through a transmission electron microscope. Computer based image analysis software is then used to determine, using quantitative stereological analysis, the Apparent Cross Sectional Area for the fiber and the fraction of that area occupied by the polymer.

Apparatus

A transmission electron microscope having an accelerating voltage of at least 100 Kv is suitable. A exemplary instrument is the Philips Model CM120 microscope available from Phillips Technologies of Cheshire, Conn.

Suitable image analysis software is available from Reindeer Graphics of Ashville, N.C. as The Image Processing Toolkit 5.0.

Method

A sample of the nonwoven material to be analyzed is embedded using conventional resin embedding techniques known to the microscopic arts so as to provide sufficient contrast between the embedding medium and the nonwoven or fiber sample. The embedded sample is sectioned (section thickness of about 0.1 to 0.3 microns) in a series of random orientations that depend on the volume and concentration of the included phase (i.e., the polymer comprising the low density fibers). The number and orientation of the samples is determined using known stereological analysis techniques that are described in, for example, The Image Processing Handbook (3rd edition, CRC Press, 1998, ISBN 0-8493-2532-1). The images of the various sections are obtained using the transmission electron microscope at a magnification setting appropriate for the expected fiber diameter and strut thickness.

Once the images are obtained, they are analyzed in a random order using known image analysis techniques as described in the instructions for the aforementioned image analysis software. The image should be analyzed to determine both the Apparent Cross Sectional Area of the fiber and the apparent percentage of that cross sectional area that comprises the polymer (Percent Polymeric Area=area occupied by polymer/Apparent Cross Sectional Area).

Report

Report the number of fiber ends analyzed and the average and standard deviation for Apparent Cross Sectional Area and for Percent Polymeric Area.

Fiber Diameter

Fiber diameter (for circular fibers) or equivalent fiber diameter for fibers having a non circular cross section is determined by the following equation:

$$d = 2 \sqrt{\frac{ApparentCrossSectionalArea}{π}}$$

Fiber Density

Fiber density is determined by multiplying the average Percent Polymeric Area (in decimal form) by the polymer density.

Polymer Density

Polymer density can be determined by determining the weight of a known volume of the polymer composition used to extrude the low density fibers of the present invention where the polymer composition sample has been processed to insure that it is void free. One way to process the polymer composition for determination of polymer density is to extrude a thin film thereof from a laboratory extruder as is available from C. W. Brabender Instruments Inc. of South Hackensack, N.J.

If necessary, already spun fibers can be reextruded to insure void volume is removed in order to determine polymer density of an unknown polymer composition.

Liquid Strikethrough Time (EDANA Test Method 150.4-99)

This test method measures the strike-through time, i.e., the time taken for a known volume of liquid (simulated urine) applied to the surface of a test piece of nonwoven material, which is in contact with an underlying standard absorbent pad, to pass through the nonwoven. This test method is only designed to compare strike-through time of nonwoven. It is not intended to simulate in-use conditions for finished products.

Nonwoven Absorption (EDANA Test Method 10.3-99)

This test method covers the evaluation of the behavior of nonwoven fabrics in the presence of liquids. In particular:
the liquid absorbency time
the liquid absorptive capacity
the liquid wicking rate (capillarity).
   It should be noted that these different aspects of absorbency relate to various end uses of the tested products.
   Repellency (EDANA Test Method 120.1-80)

This test method measures the resistance of nonwoven fabrics to penetration by aqueous liquids. According to this method. the water repellent character of a nonwoven is the resistance to strike through of distilled water displayed by that nonwoven as measured by the hydrostatic head required for strike through.

Capillary Sorption

In the Capillary Sorption experiment, capillary sorption absorbent capacity is measured as a function of fluid pressure due to the height of the sample relative to the test fluid reservoir (hydrostatic head). A porous glass frit is connected via an uninterrupted column of fluid to a fluid reservoir on a balance. The sample is maintained under a constant confining weight during the experiment. As the porous structure absorbs fluid upon demand, the weight loss in the balance fluid reservoir is recorded as fluid uptake, adjusted for uptake of the glass frit as a function of height and evaporation. The uptake or capacity at various capillary suctions (hydrostatic heads) is measured. Incremental absorption occurs due to the incremental lowering of the frit (i.e., increasing capillary suction). Similarly, incremental desorption occurs as the frit is raised. This test is intended to determine the height at which an absorbent structure acquires 50% of its absorbent capacity (CAH) from an unloaded starting head of 100 cm and the height at which the structure retains 50% percent of the absorbent capacity (CDH) thereof after the structure has been saturated at a zero head (Wt_{ZH}). Acquisition begins with an unloaded sample at a starting head of 100 cm. The head is incrementally decreased in order to fully saturate the sample at zero head (Wt_{ZH}) and, after the structure is saturated at zero head, the head is incrementally increased up to a hydrostatic head of 200 cm to desorb the saturated structure. Absorbent capacity at each increment is measured and a plot of capacity vs. desorption height is used to determine CAH and CDH. Details of the test method are described in U.S. Pat. No. 6,107,538.

All documents cited in the Detailed Description of the Invention are, are, in relevant part, incorporated herein by reference; the citation of any document is not to be construed as an admission that it is prior art with respect to the present invention.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

1. A nonwoven web of material suitable for use in an absorbent article, said web of material comprising a nonwoven web wherein:
a) said fibers comprising said nonwoven web comprise a multiplicity of struts which define a multiplicity of open and closed cells therebetween, said struts comprising a polymeric material having a polymer density, whereby said fibers have a fiber density that is less than said polymer density; and
b) said fibers are hydrophilic, giving said web of material the ability to absorb aqueous fluids with a liquid strike-through time of less than about 10 seconds.

2. A web of material according to claim 1 wherein said fiber density is less than 50% of said polymer density.

3. A web of material according to claim 2 wherein said fiber density is less than 25% of said polymer density.

4. A web of material according to claim 3 wherein said fiber density is less than 5% of said polymer density.

6. A web of material according to claim 1 wherein said web of material has a liquid strike-through time less than about 5 seconds.

7. A web of material according to claim 6 wherein said web of material has a liquid strike-through time less than about 3 seconds.

8. A web of material suitable for use as a core component of an absorbent article, wherein:
a) said fibers comprising said nonwoven web comprise a multiplicity of struts which define a multiplicity of open and closed cells therebetween, said struts comprising a polymeric material having a polymer density, whereby said fibers have a fiber density that is less than said polymer density; and
b) said fibers are hydrophilic, giving said material the ability to absorb aqueous fluids with an absorptive capacity of at least 4 grams per gram; and
c) said material has a CDH at which said material has released half of said absorbed aqueous fluids that is less than about 150 cm.

9. A web of material according to claim 8 wherein said material has an absorptive capacity of at least about 8 grams per gram.

10. A web of material according to claim 9 wherein said material has an absorptive capacity of at least about 10 grams per gram.

11. A web of material according to claim 8 wherein said material has a CDH that is less than about 120 cm and greater than about 50 cm.

12. A web of material according to claim 11 wherein said material has a CDH that is less than about 100 cm and greater than about 70 cm.

13. A web of material according to claim 8 wherein said material has a CDH that is less than about 40 cm.

14. A material according to claim 13 wherein said material has a CDH that is less than about 25 cm.

15. An absorbent component, said absorbent component comprising:
a) low density fibers, said fibers comprising a multiplicity of struts which define a multiplicity of open and closed cells therebetween, said struts comprising a polymeric material having a polymer density, whereby said fibers have a fiber density that is less than said polymer density; and
b) a superabsorbent polymer, said superabsorbent polymer being present at a concentration of at least about 5% by weight of said absorbent component.

16. A barrier material suitable for use in an absorbent article, said barrier material comprising a nonwoven material wherein said fibers comprising said nonwoven material comprise a multiplicity of struts which define a multiplicity of open and closed cells therebetween, said struts comprising a polymeric material having a polymer density, whereby said fibers have a fiber density that is less than said polymer density.

17. A barrier material according to claim 16 having a repellency greater than zero centimeters.

18. A wipe comprising a nonwoven web of material according to claim 1, said wipe being selected from the group consisting of polishing cloths, wet body cleansing wipes, dry body cleansing wipes, floor cleaning wipes and dish cleaning wipes.

19. An absorbent article, said absorbent article comprising at least one component selected from the group consisting of:
a) a topsheet comprising a web of material according to claim 1;
b) an acquisition layer comprising a web of material according to claim 13;
c) a distribution layer comprising a web of material according to claim 11;
d) a storage core comprising a storage component according to claim 15; and
e) a barrier cuff comprising a barrier material according to claim 16

20. A laminate, said laminate comprising:
a) a film material; and
b) a nonwoven web wherein said fibers comprising said nonwoven web comprise a multiplicity of struts which define a multiplicity of open and closed cells therebetween, said struts comprising a polymeric material having a polymer density, whereby said fibers have a fiber density that is less than said polymer density.
